(19) United States
(12) Patent Application Publication
(10) Pub. No.: US 2011/0320031 A1
(43) Pub. Date: Dec. 29, 2011

(54) MACHINING DEVICE FOR MACHINING A WORKPIECE

(75) Inventors: Peter Cornelius, Kasel (DE); Matthias Eisner, Enkirchen (DE); Thomas Hahn, Nonnweiler-Kastel (DE); Stefan Kaiser, Wadrill (DE); Helmut Kasper, Wadern (DE); Artur Klink, Saarbrucken (DE); Michael Klos, St. Wendel (DE); Christoph Olaineck, Trier (DE); Michael Schultz, Eppelborn (DE)

(73) Assignee: THYSSENKRUPP SYSTEM ENGINEERING GMBH, Heilbronn (DE)

(21) Appl. No.: 13/254,552

(22) PCT Filed: Jan. 14, 2010
(86) PCT No.: PCT/EP2010/000144

§ 371 Date: Sep. 6, 2011

(30) Foreign Application Priority Data
Mar. 6, 2009 (DE) 10 2009 012 155.2

(51) Int. Cl. G05B 19/19

(52) U.S. Cl. 700/174

(57) ABSTRACT

The invention relates to a machining device for machining a workpiece, wherein a rotatably mounted machining tool (2a) is held in a machining unit (2), and the axis of rotation (X) of the machining tool (2a) can be aligned with the workpiece surface to be machined, and therefore the axis of rotation (X) coincides with the geometric normal (N) in the machining point of the workpiece surface. The machining device comprises a pressure plate (6) mounted in a freely rotatable manner on the machining device via a bearing device (4), and a measuring device (8) for detecting a deviation in the position of the pressure plate (6). According to the invention, the bearing device (4) has a bearing body (40b) having at least one spherical surface region, and a bearing receptacle (40a) which surrounds the bearing body (40b) at the spherical surface regions in a form-fitting manner.

The invention relates to a processing device for processing a workpiece (in particular a workpiece fixed in a support device, such as a clamping frame or the like for the duration of the processing). The processing device is advantageously formed as an at least partly automated drilling device which can be aligned (in an automated manner) with its drilling tool orthogonal to a surface point on the workpiece surface to be processed, in order to be able [to produce] holes, bores and/or depressions whose bore hole axis coincides with the surface normal in the bore hole centre point on the processing surface (bores of orthogonal holes). For this purpose, the processing device comprises on the head side a pressure plate which is mounted so as to be freely movable via a bearing device and is coupled to a measuring device, wherein any position deviation of the pressure plate caused by tipping thereof (pressure plate can be tilted or pivoted through 360° about the rotational axis of the processing tool at all points)—in particular departing from a central position in which the central axis of a through-going opening in the pressure plate extending as a surface normal of the pressure plate and the rotational axis the processing tool coincide—can be detected.

Such an apparatus is already known from patent document U.S. Pat. No. 5,848,859. This document describes a drilling tool which likewise comprises a drilling machine mounted in a drilling machine housing and on whose head-side end a pressure foot is formed which on the bearing side comprises a (spherical) bearing surface which is formed as a circular segment as seen in cross-section and co-operates with a (spherical) surface in the drilling machine housing corresponding thereto. The pressure foot is kept biased via individual retaining springs with respect to the drilling machine housing in a defined starting position against the spherical bearing surface in the drilling machine housing. Tipping of the pressure foot is detected by a plurality of laterally disposed linear path measuring sensors which means that upon tipping of the pressure foot a control device for a robot arm bearing the drilling device causes the robot arm to be controlled such that orthogonal alignment of the drilling tool with respect to the surface to be drilled is effected. In this drilling device, chips produced during the drilling process are drawn off in the front region of the pressure foot directly adjacent to the bore itself.

The object of the present invention is to provide a processing device of the generic type which obviates the above-described disadvantages. In particular, the processing device in accordance with the invention is to ensure more precise or more reliable positioning/alignment of the processing tool.

In accordance with the invention, this object is achieved by the features of claim 1 taken as a whole. Advantageous developments of the invention are described in the subordinate Claims. In accordance with the present invention, it is proposed to form the bearing device, via which the pressure plate is mounted so as to be freely movable on the processing device, as a spherical joint or spherical joint bearing. The spherical joint bearing is advantageously designed to be enclosed such that the chips or the like are not able to enter into the region of the bearing point between the co-operating bearing components. Furthermore, the spherical joint bearing, which comprises at least one bearing body, comprising a spherical surface region, and a bearing receptacle surrounding the bearing body at the spherical surface regions in a positive-locking manner, ensures that the pressure plate is retained in a force-free manner, wherein no force accumulators act on the pressure plate whatsoever in order to align the pressure plate into a predetermined position (such as the central position) in a non-loaded state or to keep the pressure plate in said position. The bearing receptacle surrounding the bearing body in a positive-locking manner further ensures that the bearing body cannot be pulled out of the bearing receptacle even with the occurrence of traction or compressive forces on the pressure plate and therefore that no measurement errors resulting therefrom can occur. The type of bearing also prevents forces from undesirably acting upon the measuring sensors engaging the pressure plate. The bearing device can be formed for example by a possibly slightly modified joint bearing of the SC, SSCP type, or the like, from the company Hirschmann (GD catalogue 1905“Hochleistungsgelenkköpfe und Gelenklager” [high quality joint heads and joint bearings], page 19, 20). The alignment of the spherically mounted pressure plate, which is aligned relative to the workpiece surface when being pressed against the workpiece to be processed corresponding to the workpiece surface, is detected in particular via at least three, preferably four, distance measurements. The distance measurement can be effected on a contact basis by means of a mechanical measuring sensor or in a contactless manner, in particular optically. In the case of the position of the pressure plate being determined in a contactless manner, three or four sensor systems can be disposed so as to be distributed, in particular evenly on the periphery, about a tool passage opening in the pressure plate. Alternatively, however, the position can also be detected by only one sensor system via which the different three or [four] measuring points are then successively measured. For this purpose, the sensor system is mounted in particular so as to be freely movable. The measuring device or measuring sensor system is integrated into the processing device such that in the event of orthogonal alignment of the pressure plate lying against the workpiece surface in the processing point, all of the measurement values are equal when there are three distance measurements and at least the measurement values of each two opposite measuring sensors are equal when there are four distance measurements.

In a particularly preferred embodiment of the invention, the processing unit of the processing device is formed as a drilling unit having a drill spindle for receiving a drilling tool. In order to ensure that the pressure plate is arranged accurately in terms of position at all times even during operation (or machining), the processing device comprises, in the region remote from the pressure plate—upstream of the spherical joint as seen in the feed direction of the processing tool—a laterally arranged suction apparatus for drawing off chips and/or lubricating or cooling fluid. Owing to such an arrangement of the suction apparatus, the bearing of the pressure plate remains uninfluenced by additional force influences.

However, in other embodiments of the invention, it is also feasible to provide other processing units with rotating processing tools for machining. Therefore, the invention includes milling or countersinking tools or the like. In another preferred development of the invention, provision is made to equip the processing unit with a feed device such that the rotating processing tool can be displaced axially along its rotational axis. In addition to the bearing device, the pressure plate is advantageously a component of a pressure unit, wherein the pressure unit can likewise be displaced along the rotational axis of the processing tool via a further drive device (hereinafter also referred to as pressure drive device). The pressure drive device is formed such that the displaceability of the pressure unit is independent of the displaceability of the feed device. The pressure unit advantageously comprises a support frame which surrounds the processing unit, in particular coaxially, and can be displaced axially along the rotational axis via the pressure drive device relative to a positionally-fixed base plate. The pressure plate is connected to the support frame via the bearing device fixed to the support frame and is attached on the end face on the side remote from base plate to a bearing body (or a spherical cap of the spherical joint) mounted in a bearing receptacle (or a hollow sphere-shaped bearing sleeve) so as to be freely rotationally-movable in all directions. The bearing body and the bearing receptacle both comprise a through-going hole or opening in the direction of the rotational axis of the processing tool for the passage of the processing unit, processing tool or part thereof and also the pressure plate comprises a through-going opening corresponding to the through-going hole in the bearing body.

Owing to the processing device in accordance with the invention, in particular the pressure unit with the spherically mounted pressure plate, various problems of conventional processing devices are solved. Owing to the bearing device formed as a spherical joint, the pressure plate of the pressure unit is aligned in an automated manner tangentially to a three-dimensional, curved workpiece surface upon the pressure unit being pressed against this surface. Owing to the measurement of the tipping of the pressure plate (oscillating plate), the robot-assisted positioning of the pressure unit and the drilling unit can be corrected which means that the rotational axis of the processing tool is ultimately aligned at a desired angle (preferably orthogonal) to the component surface. Irrespective of the angle at which for example a bore to be produced via the processing tool is to be incorporated into the workpiece (at least within certain limits), the oscillating plate lies tangentially against the component/workpiece in the processing point, wherein a pressing element disposed in the region of a through-going opening in the pressure plate correspondingly seals the processing point (bore). Owing to the independent drive of the pressure unit, tolerances in the robot positioning, via which the processing device is positioned with respect to the workpiece to be processed, can be compensated for (tolerances in the component bearing and component geometry). Using optional force measurement (for this purpose the pressure unit advantageously comprises corresponding force measuring means coupled to the (robot) control device or it is coupled to corresponding force measuring means), the component to be drilled can be pressed against a support with a defined pressing force and can therefore be fixed locally. By means of an additional optional sensor system (e.g., light barrier), the tool tip can be detected which means that via the edge distance (in parallel with the rotational axis of the processing tool) between the light barrier and pressing element or between the light barrier and the end surface of the pressure plate, bores and/or depressions having a precisely defined depth can be incorporated. In order to allow the tool to be replaced in a simple manner, part of the pressure unit can be formed to be displaceable or pivotable,

The processing device in accordance with the invention for processing a workpiece operates in the following manner. In a first method step, the processing device is positioned into a desired processing position, predetermined by stored processing data, via the robot arm of an industrial robot. The desired processing position—starting from a predetermined known starting position of the industrial robot and thus starting from a known starting position of the processing device—is determined by corresponding data sets for three-dimensional positioning of the processing device relative to a workpiece which is to be processed and is positioned in a defined manner in a workpiece retaining device. If the processing device has been positioned by the robot into a predetermined x/y position at a predetermined distance (z position) from the workpiece or the workpiece position to be processed, then the pressure unit is displaced via its separate drive device in the feed direction until the pressure plate of the pressure unit lies with a predetermined force against the workpiece to be processed. The pressure plate is thus aligned on the workpiece owing to its spherical joint bearing and a check is made as to whether the present alignment of the pressure plate corresponds to the desired, predetermined alignment (in particular orthogonal to the workpiece surface in the region of the processing point). If the alignment of the pressure plate is within a predeterminable tolerance range, then processing of the workpiece commences (e.g., the drilling machine is activated and the feed device is started). If the alignment of the pressure plate is outside the predeterminable or predetermined tolerance range, then the pressure unit is displaced by a predetermined distance opposite the feed direction and re-aligned in a corrective manner in a position in which it is no longer in contact with the workpiece in dependence upon the determined positional data (deviation from the desired position to the actual position). Then the pressure unit is again driven to the workpiece until the defined contact pressure is achieved and the position of the pressure plate is re-detected and checked. This is repeated as often as necessary until the actual position of the pressure plate is within the predetermined tolerance range.

Further advantages, features and expedient developments of the invention are discussed in the following description of the Figures, in which:

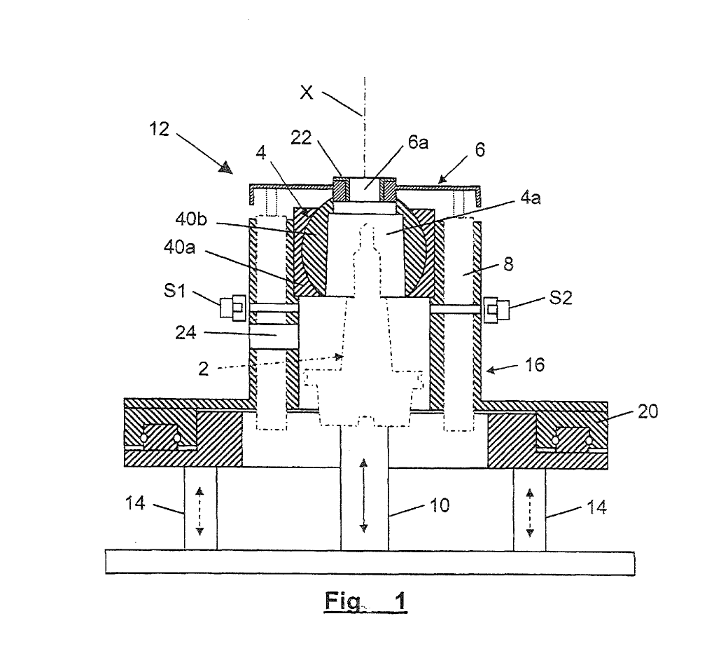

FIG. 1 shows a schematic illustration of the processing device in accordance with the invention having a processing unit formed as a drilling or countersinking unit,

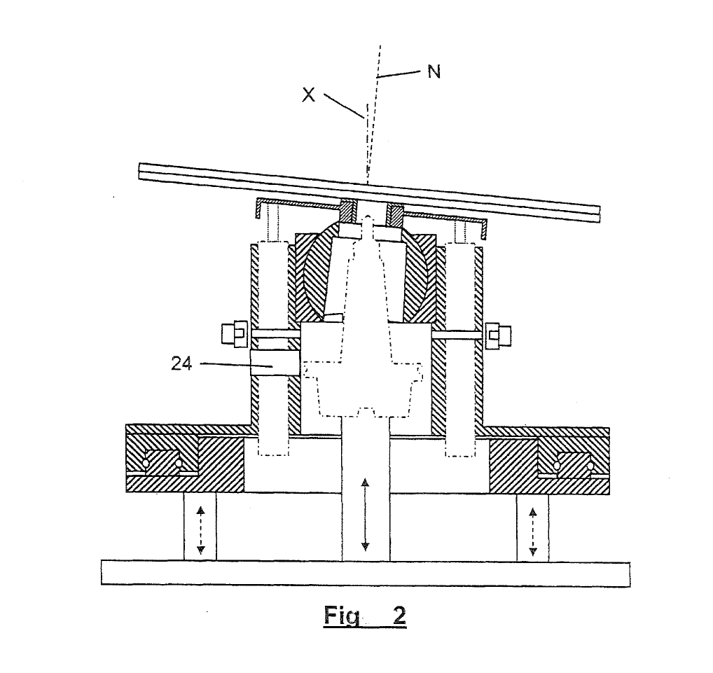

FIG. 2 shows an illustration of the processing device of FIG. 1, wherein the processing device lies with its spherically mounted pressure plate against a processing surface which is arranged inclined relative to the processing tool, and

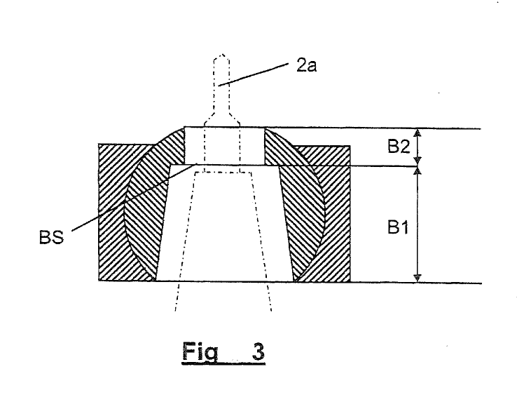

FIG. 3 shows a cross-section of the bearing device in a preferred embodiment thereof.

FIG. 1 illustrates a processing device in accordance with the invention for processing a workpiece, wherein a processing unit 2 in the form of a drilling machine is used. The drilling machine 2 is disposed/mounted so as to be able to be axially displaced along the rotational axis X (or feed axis) of the processing toot 2a via a feed device 10. The processing unit 2 can be moved in a linear reciprocating manner via the feed device 10 with respect to a base plate 18 which is disposed in a positionally-fixed manner (the base plate is the positionally-fixed component of the processing device 2). The positionally-fixed base plate 18 can be designed as a separate plate (positioned perpendicularly to the feed axis) which can be attached to such an attachment plane of a robot arm. Disposed coaxial to the processing unit 2 is a pressure unit 12 which, on its side facing a workpiece to be processed, supports a pressure plate 6 mounted via a bearing device 4 (spherical joint) and co-operates with a further drive device 14 on its side remote from the workpiece to be processed such that the pressure unit 12 can be axially displaced via this drive device with respect to the processing unit 2 or relative thereto in the direction of the rotational axis X and independent of the processing unit 2 or the feed drive 10. Disposed between the spherically mounted pressure plate 6 and the pressure unit 12 are several measuring sensors of a measuring device 8 in order to detect corresponding tipping (or the degree and direction of tipping) of the pressure plate 6 upon being pressed onto a workpiece surface to be processed. The measuring sensors are not mechanically connected to the pressure plate 6 but rather lie against it merely on the rear side of the pressure plate 6 with a predetermined low spring force. The spring force is measured (proportionally to the mass of the pressure plate) such that although the measuring sensors lie against the pressure plate 6, they are not able to move it (the pressure plate 6 can thus not be moved or even aligned into a predetermined position by the spring-loaded measuring sensors). In order to achieve alignment and position detection of the pressure plate 6 in as precise a manner free of disruption as possible, the pressure plate is mounted substantially free of forces to the extent that no force accumulators act on the pressure plate 6 (with the exception of the spring-loaded measuring sensors) in order to align it in a non-loaded state into a predetermined position—such as the central position—or to keep it in this position. In order to mount the pressure plate 6, the pressure unit 12 comprises a substantially hollow-cylindrical support frame 16 which, on its side remote from the workpiece (or the side facing the base plate 18) comprises a cap collar-like protrusion which means that, as seen in cross-section, a double L shape is formed, wherein the long limbs of the Ls lie opposite each other in parallel and wherein the short limbs of the Ls point outwards in opposite directions. The measuring sensors 8 are accommodated in the support frame 16 or are integrated therein at least in regions. This produces on the one hand an extremely compact construction and on the other hand the measuring sensors 8 are protected against mechanical influences or other influences. As a further protective measure for the measuring sensors 8, provision is made for an anti-rotation device (not illustrated) of the pressure plate 6. This anti-rotation device consists substantially of a ball which runs in a groove of a lateral surface of the pressure plate 6 and which is attached to a pin having a small diameter and is supported via this pin on the support frame 16 or on another component which is positionally-fixed relative to the pressure plate 6.

Furthermore, disposed opposite each other on the hollow-cylindrical region of the support frame 16 of the pressure unit 12 are two corresponding light barrier elements S1, S2 by means of which the position of the processing tool 2a is to be detected. The position is determined for example by detecting the tip of the processing tool 2a and this serves in particular to determine a drilling or countersinking depth to be achieved in the workpiece to be processed. The position is determined once at least after each time the tool is replaced at the beginning of a start-up procedure. For this purpose, the processing unit 2 with the processing tool 2a supported thereby is moved backwards starting from a rest position illustrated in FIG. 1 until the tip of the processing tool 2a (e.g., cross-cutter of a spiral drill) leaves the region of the light barrier elements S1, S2 (light barrier no longer interrupted) and is then slowly moved forwards until the light barrier of the light barrier elements S1, S2 is broken by the tip of the processing tool 2a. Owing to the defined position (known distance of the light barrier to the end surface of the pressure plate 6 or to the end surface of the pressing element 22—hereinafter also referred to as free travel) of the light barrier elements S1, S2 to the end surface of the spherically mounted pressure plate 6, the corresponding drilling or countersinking depth can be determined in a simple manner (drilling or processing depth=total feed travel−free travel; or feed travel required for the desired processing depth=free travel+desired processing depth).

In order for the position determination or the relative position of the processing tool 2a (defined by its rotational axis X) to the surface normal N to be able to be precisely determined at the point of the workpiece surface to be processed, the pressure plate 6 is formed such that a defined arrangement of the pressure plate 6 as close as possible to the surface position to be processed is effected, For this purpose, the through-going opening 6a in the pressure plate 6 is dimensioned so as to be adapted to the processing tool 2a to be passed through this opening 6a (e.g., through-going opening in the pressure plate 6 or pressing element 22 is only slightly greater than the diameter of the processing tool). On its side facing the workpiece to be processed, the pressure plate 6 advantageously comprises a pressing element 22 in the region of the through-going opening 6a. This pressing element 22 is preferably attached to the pressure plate 6 in a replaceable manner and consists for example of materials such as Teflon, metal, synthetic material or a ceramic material. The material for the pressing element 22 is selected in dependence upon the material of the workpiece to be processed and/or in dependence upon its surface qualities. The pressing element 22 can be accordingly structured on its surface facing the workpiece so that contact with the workpiece to be processed only occurs in the region of predetermined elevations. Furthermore, the pressing element 22 can also consist of individual segment parts, in particular of segment parts of a circular ring.

In order to be able to ensure that the processing tool 2a can be replaced as conveniently as possible (e.g., replacing a drill by a countersinking drill or a drill having another diameter), the pressure unit 12 is formed accordingly. For this purpose, the support frame 16 can be displaced for example with respect to its drive device 14 or with its drive device 14 transverse to the rotational axis X of the processing tool 2a via a rail guide 20. Alternatively, it is also feasible for the support frame 16 to be mounted in a pivotable manner transverse to the rotational axis X of the processing tool 2a via a hinge or a corresponding joint connection—not illustrated.

FIG. 2 illustrates the processing device in accordance with the invention with the processing unit 2 in an operating position different from that of FIG. 1. The processing unit 2 is driven to the surface of the workpiece to be processed in the form of a drilling machine with its corresponding drill as a processing tool 2a. Since in the illustrated exemplified embodiment the workpiece surface to be processed is positioned so as to extend in an inclined manner relative to the processing unit 2, the pressure plate 6 is correspondingly pivoted. The measuring sensors (linear path measuring sensors) of the measuring device 8 detect the extent and direction (which measuring sensors are extended relative to a central position by which amount and which measuring sensors are shortened relative thereto?) of the pivoting of the pressure plate 6, starting from a central position in which the central axis of the through-going opening 6a extending as a surface normal N of the pressure plate 6 and the rotational axis X of the processing tool 2a coincide, and the corresponding measurement values are forwarded to a corresponding evaluating and control device of an industrial robot (not illustrated) bearing the processing device 2. The evaluating unit can now determine the angle at which the drilling tool 2a is aligned with respect to the processing surface. If a bore deviating from this angle (e.g., an orthogonal bore) is to be produced, then the industrial robot can now align the processing device 2 and thus the processing tool 2a or the processing unit 2 accordingly. Furthermore, the pressure unit 12 or its support frame 16 is fitted with a suction channel 24 which is particularly disposed transverse to the feed axis which means that workpiece components (such as chips or the like) removed during processing of the workpiece and/or excess cooling or lubricating agents can be kept away from the pressure region of the pressure plate 6. In another embodiment of the invention, various suction channels can even be provided for the drawing-off of material components on the one hand and the drawing-off of excess cooling or lubricating agents.

FIG. 3 illustrates a preferred embodiment of the spherical joint 4. In accordance therewith, the through-going hole 4a in the spherical cap 40b of the spherical joint 4 is designed in the form of a stepped bore. The first axial bore part B1 is the one with the larger diameter, to which a second bore part B2 having a smaller diameter is connected via a bore step BS. The pressure plate 6, not illustrated, is disposed on the end face in the region of the through-going hole 4a on the side of the smaller diameter. In the illustrated exemplified embodiment, the first bore part B1 is designed in the manner of a truncated cone. Owing to the bore part B1 having a larger diameter, a chamber for the intermediate reception of chips is formed in a simple manner, which chips are continuously carried away via the suction device.

List of Reference Numerals
2 Processing unit (drilling machine)
   Processing tool (drill)
   X Rotational axis [symbol]
   Pressing element (pressure plate)
24 Suction channel
S1, S2 Light barrier element

1. Processing device for processing a workpiece, wherein a processing tool (2a), which is mounted so as to be able to rotate, is held in a processing unit (2), and the processing tool (2a) can be aligned with its rotational axis (X) with respect to the workpiece surface to be processed which means that the rotational axis (X) coincides with the geometric normal (N) at the processing point of the workpiece surface,
comprising
a pressure plate (6) which is mounted so as to be freely movable on the processing device via a bearing device (4), wherein the bearing device (4) and also the pressure plate (6) both have a through-going opening (4a; 6a) for the processing tool (2a), and
a measuring device (8) for detecting a deviation between the rotational axis (X) and the surface normal (N) at the processing point owing to the alignment of the pressure plate (6) at the surface of the workpiece in the region of the processing point,
characterised in that
the bearing device (4) comprises a bearing body (40b), comprising at least one spherical surface region, and a bearing receptacle (40a) surrounding the bearing body (40b) in a positive-locking manner at the spherical surface regions.

2. Processing device as claimed in claim 1, characterised in that the processing unit (2) is designed as a drilling unit having a drill spindle for receiving a processing tool (2a).

3. Processing device as claimed in claim 1, characterised in that
the processing unit (2) comprises a feed device (10) via which it can be displaced axially along the rotational axis (X).

4. Processing device as claimed in claim 3, characterised in that
the pressure plate (6) and the bearing device (4) are formed as components of a pressure unit (12),
and the pressure unit (12) can be axially displaced via a drive device (14) with respect to the processing unit (2) in the direction of the rotational axis (X) and independent of the processing unit (2).

5. Processing device as claimed in claim 4, characterised in that the pressure unit (12)
comprises a support frame (16) which accommodates the bearing device (4) and can be displaced in the axial direction along the rotational axis (X) via the drive device (14) relative to a base plate (18) and also relative to the processing unit (2),
wherein the bearing receptacle (40a) comprises axially opposing passage openings for the processing tool (2a), and the bearing body (40b), in the direction of the rotational axis (X), comprises a through-going hole aligned with the passage openings in the bearing receptacle (40a) and on its side of the through-going hole remote from the base plate (18) supports the pressure plate (6) with a pressure plate opening (6a) arranged coaxially to the through-going hole.

6. Processing device as claimed in claims 4, characterised in that the pressure unit (12) or parts thereof can be moved from an operating position in which it surrounds the processing tool (2) in a substantially coaxial manner into a tool replacement position in which the processing tool (2) is released.

7. Processing device as claimed in claim 6, characterised in that the support frame (16) is mounted so as to be displaceable transverse to the rotational axis (X) of the processing tool (2) via a rail guide (20) or so as to be pivotable transverse to the rotational axis (X) of the processing tool (2) via a joint connection.

8. Processing device as claimed in claim 1, characterised in that the pressure plate (6) comprises a pressing element (22) on its side remote from the bearing device (4) in the region of the through-going opening (4a).

9. Processing device as claimed in claim 8, characterised in that the pressing element (22) has a structured surface on its side facing the workpiece to be processed such that the pressing element (22) contacts the workpiece to be processed only in the region of predetermined elevations.

10. Processing device as claimed in claims 9, characterised in that the pressing element (22) consists of individual segment parts.

11. Processing device as claimed in an claim 1, characterised in that the measuring device (8) includes a plurality of path measuring sensors which detect the movement of individual points of the pressure plate (6) resulting from the pressure of the pressure plate (6).

12. Processing device as claimed in claim 1, characterised in that the measuring device (8) is disposed between the support frame (16) and the pressure plate (6).

13. Processing device as claimed in claim 5, characterised in that the support frame (16) accommodates the measuring device (8).

14. Industrial robot having a spatially movable support arm which supports a processing device (2) as claimed in claim 1.
